(19) United States
(12) Patent Application Publication
(10) Pub. No.: US 2023/0090411 A1
(43) Pub. Date: Mar. 23, 2023

(54) CORRECTION OF GEOMETRIC MEASUREMENT VALUES FROM 2D PROJECTION IMAGES

(71) Applicant: Siemens Healthcare GmbH, Erlangen (DE)

(72) Inventors: Andreas FIESELMANN, Erlangen (DE); Ramyar BINIAZAN, Nuernberg (DE); Christian HUEMMER, Lichtenfels (DE)

(73) Assignee: Siemens Healthcare GmbH, Erlangen (DE)

(21) Appl. No.: 17/948,454

(22) Filed: Sep. 20, 2022

(30) Foreign Application Priority Data
Sep. 23, 2021 (EP) 21198444.8

(51) Int. Cl. G06T 5/00; G06T 7/00; G06T 7/73

(52) U.S. Cl. CPC G06T 5/006; G06T 7/0012; G06T 7/75

(57) ABSTRACT

According to a method for correcting a 2D measurement value is described, 2D image data of an examination object is received. Landmarks in the 2D image data are detected, and 2D positions of the landmarks are calculated. A corrected measurement value of the examination object is predicted, using a trained model, which depends on the received 2D image data, the estimated 2D positions of the landmarks and a reference parameter of a reference 3D orientation of the examination object.

### CROSS-REFERENCE TO RELATED APPLICATION(S)

The present application claims priority under 35 U.S.C. § 119 to European Patent Application No. 21198444.8, filed Sep. 23, 2021, the entire contents of which are incorporated herein by reference.

### FIELD

One or more example embodiments of the present invention relate to a method for correcting geometric measurement values. One or more example embodiments of the present invention also concern a correction device. Further, one or more example embodiments of the present invention relate to a medical imaging system.

### BACKGROUND

Two-dimensional (abbreviated: 2D) X-ray images are commonly used for measurements. For this purpose, usually anatomical or non-anatomical, for example, device based, landmarks are identified in the image and distance and/or angles are measured. However, the location of the landmarks in the 2D image can change based on a three-dimensional (abbreviated: 3D) orientation of an organ being examined. Thus, also the measurement values can change based on the 3D orientation of the organ.

A dependency of the 2D measurement value on the 3D organ orientation poses certain problems:

A non-standard 3D organ orientation in a patient's X-ray exam can bias the measurement values and negatively impact comparison of these values to values from existing guidelines.

When follow-up exams of the same patient are acquired in different 3D organ orientation the resulting difference in measurement value may be misinterpreted as being caused by an actual anatomical change.

Studies have shown that for a long-leg X-ray exam, the rotation of the limb, knee or foot have statistically significant impact on the measurement values. As an example, the study by Jamali et al (2017), “Do small changes in rotation affect measurements of lower extremity limb alignment?”, Journal of Orthopaedic Surgery and Research, 12:77, https://doi.org/10.1186/s13018-017-0571-6 indicates that for some parameters, even a 3° rotational deviation can lead to a statistically significantly different value. Such different values are illustrated in FIG. 1, which is taken from Jamali et al.

### SUMMARY

Hence the inventors have discovered that there is a problem of a deviation of measurement values of 2D medical images.

The before-mentioned problem is solved by a method for correcting a 2D measurement value according to one or more example embodiments of the present invention, by a correction device according to one or more example embodiments of the present invention and/or by a medical imaging system according to one or more example embodiments of the present invention.

According to the method for correcting a 2D measurement value, 2D image data, preferably X-ray image data, of an examination object are received, for example from a data source or an X-ray imaging system.

The 2D measurement value to be corrected is taken from the 2D image data. Preferably, the 2D measurement value comprises a measurement value of a part of the body of a patient. For example, in case an image is taken from the lower limb of a patient, the measurement value can comprise at least one of the measurement values like mLDFA, MPTA, mTFA, aTFA, AMA and aLDFA as illustrated in FIG. 1.

The 2D measurement value based on the 2D image data may deviate from the correct 2D measurement value, since the orientation of the examination object in the 2D image data may differ from a reference orientation. Further, landmarks are detected in the 2D image data and the 2D positions of the landmarks are estimated. In this context, it has to be mentioned that a landmark is assigned to an unambiguous position in the 2D image data. Furthermore, the corrected 2D measurement value of the examination object is predicted using a trained model, which depends on the received 2D image data, the estimated 2D positions of the landmarks and a reference parameter of a reference 3D orientation of the examination object. As later discussed in detail, the corrected measurement value comprises preferably a statistical quantity, i.e. a probability density function.

For explaining the method in more details, we set some definitions:

Firstly, we define a transformation from 3D domain to 2D domain:

a=P(r,o). (1)

Thereby, o are the 3D orientation parameters of the examination object, for example an organ, also named organ orientation parameters, in an object-specific coordinate system, r are the 3D positions of organ landmarks and P is the projection from 3D to 2D.

Secondly, we define a transformation from 2D positions of landmarks to 2D measurement:

m=M(a). (2)

Thereby, a are the 2D positions of organ landmarks, i.e. landmarks of the examination object, M is the 2D measurement definition and m is the 2D measurement value.

From equation (1) and (2), it can be taken that the 2D measurement value m is a function of the 3D orientation parameters o.

If the 3D orientation parameters o of the examination object are different from the reference orientation parameters due to a specific anatomy and indication, we would like to know, how the 2D measurement value m would be, if the examination object would have been positioned in the reference position. Thus, a model Z is defined that predicts measurement values for different organ orientation parameters.

Formally, we define the corrected measurement value:

m\hat{ }_pdf=Z(a,I,oref), (3)

wherein oref are reference 3D orientation parameters for a specific anatomy and indication, I is an X-ray image comprising the 2D image data, a is a 2D position of organ landmarks, Z is a model that predicts a measurement value for a reference orientation oref and m \hat{ }_pdf is an estimated measurement value, preferably an estimated probability density function pdf of an estimated measurement value. The probability density function pdf can be parameterized, for example by mean value and standard deviation for a Gaussian pdf.

Advantageously, the method, according to one or more example embodiments of the present invention, supplies a kind of support for a doctor for estimating a measurement value m of an examination object, for example an organ, based on an automatically determined orientation o and a reference orientation oref.

The data correction device, according to one or more example embodiments of the present invention, comprises an input interface unit for receiving 2D image data of an examination object, a landmark detection unit for detecting landmarks in the 2D image data and estimating the 2D positions of the landmarks and a prediction unit for predicting a corrected measurement value of the examination object using a trained model, which depends on the received 2D image data, the estimated 2D positions of the landmarks and a reference parameter of a reference 3D orientation of the examination object. The correction device shares the advantages of the method for correcting a 2D measurement value according to one or more example embodiments of the present invention.

The medical imaging system, preferably an X-ray imaging system, according to one or more example embodiments of the present invention comprises an acquisition unit for acquiring measuring data, i.e. raw data, from an examination object, a post-processing unit for generating post-processed image data based on the acquired measuring data and a correction device according to one or more example embodiments of the present invention. The medical imaging system shares the advantages of the correction device according to one or more example embodiments of the present invention.

The essential components of the correction device, according to one or more example embodiments of the present invention, can for the most part be designed in the form of software components. This applies in particular to the landmark detection unit and the prediction unit of the correction device, but also parts of the input interface. In principle, however, some of these components can also be implemented in the form of software-supported hardware, for example FPGAs or the like, especially when it comes to particularly fast calculations. Likewise, the required interfaces, for example if it is only a matter of transferring data from other software components, can be designed as software interfaces. However, they can also be designed as hardware-based interfaces that are controlled by suitable software. Furthermore, some parts of the above-mentioned components may be distributed and stored in a local or regional or global network or a combination of a network and software, in particular a cloud system.

A largely software-based implementation has the advantage that medical imaging systems that have already been used, can easily be retrofitted by a software update in order to work in the manner according to one or more example embodiments of the present invention. In this respect, the object is also achieved by a corresponding computer program product with a computer program that can be loaded directly into a memory device of, for example, a medical imaging system, with program sections, in order to carry out all steps of the method according to one or more example embodiments of the present invention, if the program is executed in the medical imaging system. In addition to the computer program, such a computer program product may contain additional components such as a documentation and/or additional components, including hardware components such as hardware keys (dongles etc.) for using the software.

For transport to the medical imaging system and/or for storage on or in the medical imaging system, a computer-readable medium, for example a memory stick, a hard disk or some other transportable or permanently installed data carrier is used on which the program sections of the computer program that can be read in and executed by a computer unit of the AI-based analysis system are stored. The computer unit can comprise for example, one or more cooperating microprocessors or the like used for this purpose.

The dependent claims and the following description each contain particularly advantageous embodiments and developments of the present invention. In particular, the claims of one claim category can also be further developed analogously to the dependent claims of another claim category. In addition, within the scope of the present invention, the various features of different exemplary embodiments and claims can also be combined to form new exemplary embodiments.

In a variant of the method for correcting a 2D measurement value according to one or more example embodiments of the present invention the examination object comprises at least one of the following object types:
an organ of a patient,
a part of the body of a patient,
a limb of a patient,
a chest of a patient.

In particular movable parts of the body like an upper or lower limb can be imaged from different rotation directions. In that context, it is very advantageous to correct measurement values such that they are comparable with a reference orientation.

In case of the limb exam, in particular a lower limb X-ray exam, many different parameters can be measured, which depend on the limb rotation to a different extend. Often several exams are acquired of the same patient at different time points and the measurement values should be compared. Today, doctors make these measurements unassisted and may take limb rotation subjectively into account. To aid doctors and to make the measurements more objective, the method according to one or more example embodiments of the present invention can be applied in the following manner:

First, each X-ray image of a patient is measured conventionally based on the landmarks in the 2D image. A doctor sets the landmarks or, in a preferred scenario, an algorithm finds the landmarks. After that, the preliminary measurement values are calculated based on these 2D landmarks in the traditional way. In addition, based on the method according to one or more example embodiments of the present invention, the rotation of the limb, preferably the probability density function of the limb rotation, is estimated taking into account X-ray image data I and in further, the measurement values concerning to the lower limb, for example the MPTA, aTFA, aLDFA values, are predicted as if there was no limb rotation. Then, for transparency, the doctor can analyse both results, the uncorrected original measurement values and the corrected results, for example with 95% confidence interval. The doctor can then interpret the uncorrected or corrected values or an algorithm can support with the interpretation of the values.

In case of a chest X-ray exam the positioning of an external device, e.g. a line, in the chest X-ray images can be checked. Here, the measurement value relates to the distance between the line's tips and anatomical structures, for example the carina, to, for example, compare device locations in sequential examinations. Such an examination is highly relevant in practice. For estimating a rotation of the chest, reference landmarks are obtained from the chest X-ray images.

Then, the rotation and tilting information is determined based on the reference landmarks of the current 2D image as it is done in clinical routine. For instance, distances between sternoclavicular joints and spine in chest X-ray images are used to estimate patient rotation. Having landmarks segmented as heatmaps, it is easily achievable to derive a probability distribution for the rotation of the chest using this approach. In that context, a linear transformation of normally distributed variables is used, which relates to a Gaussian probability density function. After that, the distance as if there would be no rotation is determined by transforming one probability distribution, which is related to the measured distances in actual X-ray image to another probability distribution, which is related to the measured distances as if there would be no rotation.

In a further variant of the method for correcting a 2D measurement value according to one or more example embodiments of the present invention, the trained model comprises a first trained model and a second trained model to be carried out one after another. Advantageously, the subdivision into two separate tasks makes an automated correction possible.

In another variant of the method for correcting a 2D measurement value according to one or more example embodiments of the present invention, the input of the first model comprises the 2D image data and the output of the first model comprises the estimated 3D orientation parameters. To implement the first model, the concept of cross-modality training data generation can be employed. That means that images from one modality, e.g. a CT system, are used to generate a multitude of synthetic images similar to those of another modality, e.g. an X-ray imaging system, corresponding to different object orientation parameter values. Advantageously, the data basis for the training data does not need to be very extensive, since synthetic images with different parameters are generated based on a relatively small data basis.

Further, the input for the second model comprises the estimated 3D orientation parameters, the reference parameter of a reference 3D orientation of the examination object and the 2D measurement value, depending on the estimated 2D positions to be corrected. The output of the second model comprises the corrected measurement value. To implement the second model, the concept of cross-modality training data generation can also be employed. By creation of synthetic X-ray images from the same CT volume with different 3D orientations, one can determine once: the 2D measurement value for the reference 3D orientation, and N times the 2D measurement value m for a 3D non-reference orientation. N is the number of synthetics X-ray images with other orientations. This enables to generate a multitude of synthetic X-ray images corresponding to different organ orientation parameters as a training data source. That approach is much easier to implement than a collection of this data by human annotation.

The subdivision into two separate tasks, wherein the first task comprises the prediction of the actual organ orientation parameters from the image data and the second task comprises the transformation of the measurement value between two different organ orientation parameter values, makes an automated correction possible. It also makes the correction procedure transparent by providing an easy-to-interpret intermediate value to the human user.

To do so, the task of model Z is subdivided into two separate tasks:

The first task is predicting actual organ orientation parameters from an X-ray image, i.e. 2D image data.

The second task is transforming measurement values between two values between two different organ orientation parameters.

For prediction of organ orientation parameters from an X-ray image, it is defined:

o\hat{ }_pdf=U(I) (4),

wherein I is an X-ray image, U is the model to predict organ orientation parameters from an x-ray image and o\hat{ }_pdf is an estimated orientation of an object or organ, preferably the estimated probability density function pdf of 3D orientation parameters, the probability density function pdf can be parameterized, e.g. with a mean value and standard deviation for a Gaussian pdf.

The model U can be implemented using a deep learning model with two possible approaches:

A first approach is an end-to-end regression approach. The second approach is a segmentation/landmark detection approach followed by rule-based parameter estimation.

The prediction of a measurement value with reference organ orientation parameters can be defined as follows:

m\hat{ }_pdf=V(m,o\hat{ }_pdf,oref) (5)

wherein oref are the reference 3D orientation parameters for the specific anatomy and indication, o\hat{ }_pdf concerns 3D orientation parameters, preferably an estimated probability density function of 3D orientation parameters of an organ or examination object, m is a 2D measurement value, V symbolizes a model to predict a measurement value, m\hat{ }_pdf concerns an estimated measurement value, preferably an estimated probability density function of measurement value assuming reference 3D orientation parameters oref.

In a further variant of the method for correcting a 2D measurement value according to one or more example embodiments of the present invention, the input of the second trained model comprises a difference between the estimated 3D orientation and the reference 3D orientation.

A particular implementation of V is defined as follows:

m\hat{ }_pdf=V(m,o\hat{ }_pdf,oref)=W(m,d) (6)

d=D(o\hat{ }_pdf,oref), (7)

wherein d is a difference between two 3D orientation parameters, in the simple case of two scalars, for example rotation values, this can be d=D(a,b)=a−b.

W is the model to predict a measurement value based on a difference d in 3D orientation parameters. Preferably, W is an AI (AI=artificial intelligence) based model, which can be generated by training an artificial neural network structure. A special variant of an AI based model comprises a deep learning model (abbreviated: DL model). Deep learning is part of a broader family of machine learning methods. The adjective “deep” in deep learning refers to the use of multiple layers in the network. Deep learning is appropriate for progressively extracting higher-level features from images.

To implement the model W, again the concept of cross-modality training data generation can be employed. By creation of synthetic X-ray images from the same CT volume with different 3D orientations, one can create an extensive training data basis for training the model W.

To train a model W that predicts a corrected measurement value m \hat{ }_pdf based on a 2D measurement value m and the difference d=D(o\hat{ }_pdf, oref), labelled training image data can be generated with the following parameters and orientations:
Once: the estimated 2D measurement value or the corresponding possibility density function m \hat{ }_pdf for the reference 3D orientation oref,
N times: the 2D measurement value m for a 3D non-reference orientation o\hat{ }_pdf.

In a variant of the method for correcting a 2D measurement value according to one or more example embodiments of the present invention, the first trained model is trained by a multitude of synthetic X-ray images of the examination object corresponding to different 3D orientation parameters. As mentioned above, this approach is much easier to implement than a collection of these data by human annotation.

The first trained model can be realized by an end-to-end approach. In this approach, the organ orientation parameters o\hat{ }_pdf are predicted directly from the image. To train the model, for example a DL model, the concept of cross-modality training data generation can be employed. Tomographic images can be used to generate a multitude of synthetic X-ray images corresponding to different organ orientation parameters. Input data for the DL model training are the synthetic X-ray images, output of the DL model is the pdf of the organ orientation parameters o\hat{ }_pdf.

Alternatively, the first trained model comprises the step of carrying out the segmentation, which is trained by a multitude of synthetic X-ray images, wherein the output of the model is a label mask with segmentations.

Then, preferably, measurement values are derived from the positions of anatomical structures in the label mask and the 3D orientation parameters are determined based on the measurement values.

This variant is also named the segmentation approach.

In this approach first relevant anatomical structures are segmented, and the locations of these structures are used to predict the organ orientation parameters o\hat{ }_pdf based on measurements. Input data for the model training are the synthetic X-ray images, output of the model is a label mask with the pixel-level segmentations. From the label mask, measurements are made to predict a pdf of the organ orientation parameters o\hat{ }_pdf.

As an example, the following mathematical equation is suggested to predict the knee rotation based on a segmentation of the fibula and tibia:

o\hat{ }=−14.20

−[0,17*vp (%)+0.35*op (%)+0.31*dist (%)], (8)

wherein o\hat{ } is the rotation of the knee, vp is the visible part of the fibula, op is the overlapped part of the fibular tip and dist is the distance between the fibular tip and the lateral fibular cortex. Equation (8) is taken from Maderbacher et al. (2014), “Predicting knee rotation by the projection overlap of the proximal fibula and tibia in long-leg radiographs”, Knee Surg Sports Traumatol Arthrosc, 22:2982-2988, http://doi.org/10.1007/s00167-014-3327-4.

To train the model, again the concept of cross-modality training data generation can be employed, as described above. Segmentation of anatomical structures can be carried out in the domain of the CT images and segmentations can be forward projected onto 2D.

This approach is more robust and has better transparency for a human compared to the end-to-end regression approach.

In a further variant of the method for correcting a 2D measurement value according to one or more example embodiments of the present invention, the step of estimating the 3D orientation parameters comprises segmenting anatomical structures of the 2D image data and localizing these segmented anatomical structures and predicting the 3D orientation parameters based on the positions of the localized anatomical structures. In this preferred variant, the determining of the orientation parameters is divided in a plurality of separated tasks, wherein the first step of a segmentation is based on a trained model. Advantageously, the results of the model can be more easily validated by a doctor than compared to a variant, wherein the orientation parameters are estimated a single step.

In a further variant of the method for correcting a measurement value according to one or more example embodiments of the present invention, the estimation of 3D orientation parameters in the 2D image data comprises an estimation of a probability density function o\hat{ }_pdf of the 3D orientation parameters in the 2D image. Advantageously, a confidence interval can be indicated, which supplies an additional information about the reliability of the estimated orientation value.

In a further variant of the method for correcting a measurement value according to one or more example embodiments of the present invention, the prediction of the corrected measurement value of the examination object comprises the determination of a probability density function m \hat{ }_pdf of the corrected measurement value.

Advantageously, a confidence interval can be indicated, which supplies an additional information about the reliability of the corrected measurement value.

### BRIEF DESCRIPTION OF THE DRAWINGS

Example embodiments of the present invention are explained below with reference to the figures enclosed once again. The same components are provided with identical reference numbers in the various figures.

The figures are usually not to scale.

FIG. 1 shows some exemplary illustrations of medical images of limbs and related measurement values depending on the orientation of the limbs in the medical images,

FIG. 2 shows a flow chart diagram illustrating the method for correcting a 2D measurement value according to an embodiment of the present invention,

FIG. 3 shows a flow chart diagram illustrating step 2.IV depicted in FIG. 2,

FIG. 4 shows a flow chart diagram illustrating step 2.V depicted in FIG. 2,

FIG. 5 shows a schematic view on a correction device according to an embodiment of the present invention,

FIG. 6 shows a flow chart diagram illustrating the method for correcting a 2D measurement value according to a second embodiment of the present invention,

FIG. 7 shows a schematic view on a table related to a comparison of original values, i.e. preliminary measurement values m with corrected measurement values for lower limb image data,

FIG. 8 shows a flow chart diagram illustrating the method for correcting a 2D measurement value according to a third embodiment of the present invention, and

FIG. 9 shows a schematic view on an X-ray imaging system according to an embodiment of the present invention.

### DETAILED DESCRIPTION

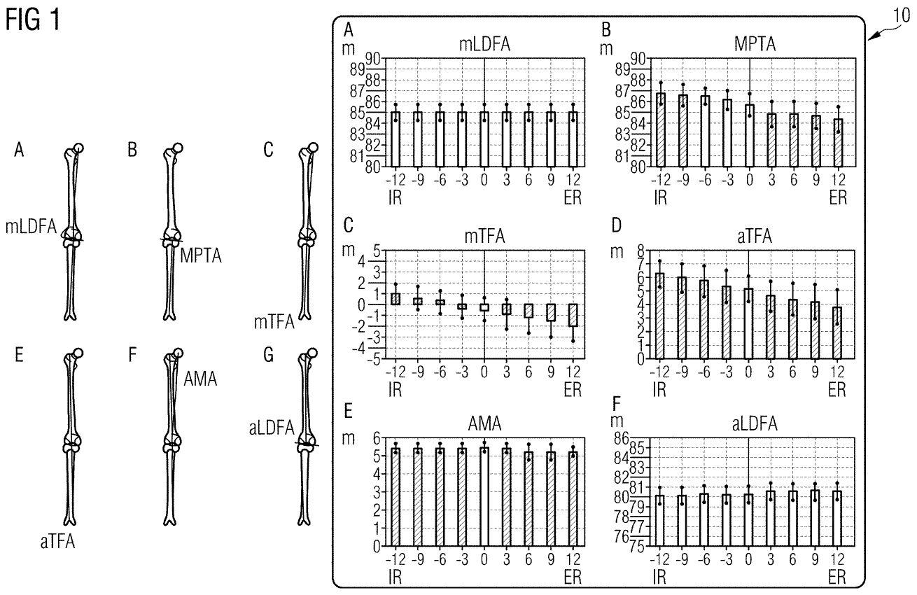

In FIG. 1, a chart 10, illustrating measurement values related to six different measurement methods of different common parameters of lower extremity alignment is depicted. On the left side, the different measurement methods are illustrated under the letters A, B, C, E, F, G.

The letter A is assigned to the mLDFA measurement, which provides a measurement value of a mechanical lateral distal femoral angle, abbreviated with mLDFA. That measurement value mLDFA is defined as the lateral angle between the femoral mechanical axis and the distal femoral articular axis.

The letter B is assigned to the MPTA measurement, which provides the measurement value of the medial proximal tibial angle. That measurement value MPTA is defined as the medial angle between the mechanical axis of the tibia and the proximal tibial articular axis.

The letter C is assigned to the mTFA measurement, which provides the measurement value of the mechanical tibiofemoral angle. That measurement value is defined as the angle between the femoral mechanical axis and the tibial mechanical axis with a positive value indicative of a valgus alignment and a negative value indicative of a varus alignment of the lower extremity.

The letter E is assigned to the aTFA measurement value, which provides the measurement value of the anatomic tibiofemoral angle. That measurement value is defined as the angle between the anatomical axis of the femur and the anatomical-mechanical axis of the tibia. A positive value is indicative of a valgus and a negative value is indicative of a varus alignment of the lower extremity.

The letter F is assigned to the AMA measurement value, which provides the measurement value of the angle between the mechanical and anatomical axes of the femur.

The letter G is assigned to the aLDFA measurement value, which provides the measurement value of the angle between the anatomical axis of the femur and the distal femoral articular axis.

On the right side of FIG. 1, measurement values m in degree are shown related to different rotations of the lower limb in the corresponding X-ray images. “IR” means internal rotation and is related to negative values of the rotation of the lower extremity and “ER” means external rotation of the lower extremity and is related to positive values of the rotation of the lower extremity. Dashed bars are concerned to values with a significant difference relative to the baseline of 0° measurement. As can be taken from FIG. 1, the measurement values of the MPTA, mTFA, aTFA and AMA measurement significantly depend on the orientation of the lower extremity in the X-ray image. Further information about the effect of rotation on various measured parameters of lower extremity alignment can be read in Jamali et al., “Do small changes in rotation affect measurements of lower extremity limb alignment?”, Journal of Orthopaedic Surgery and Research (2017) 12:77 DOI 10.1186/s13018-0571-6.

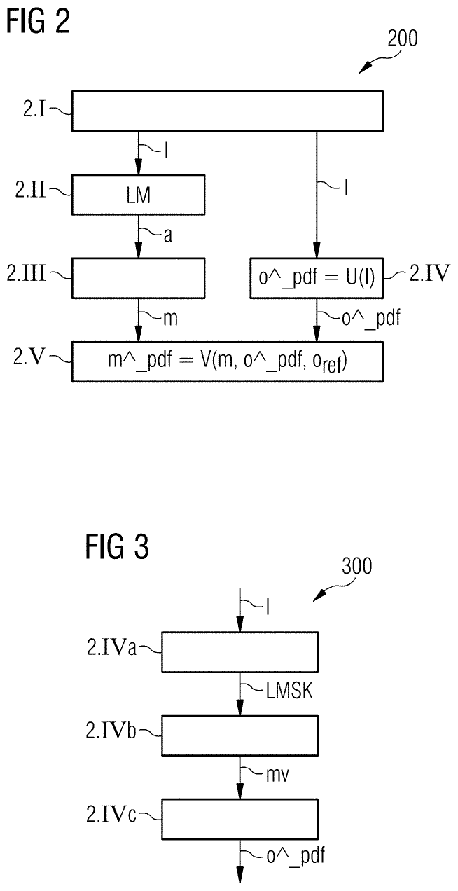

FIG. 2 shows a flow chart diagram 200 illustrating the method for correcting a 2D measurement value according to an embodiment of the present invention.

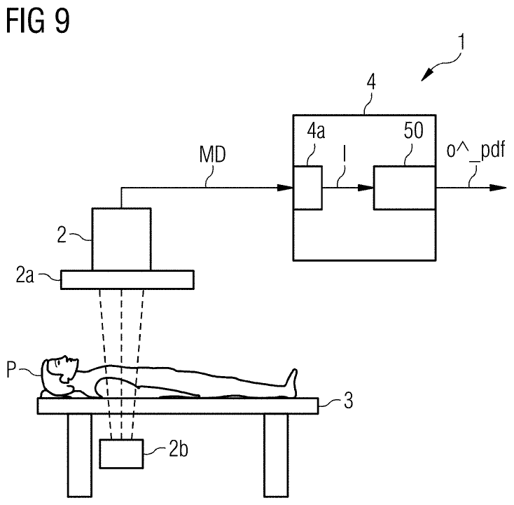

In step 2.I, 2D image data I of an examination object, in that special embodiment, a lower extremity, are received from a post-processing unit 4a (shown in FIG. 9).

In step 2.II, landmarks LM are detected in the 2D image data I, wherein the 2D positions a of the landmarks LM are estimated.

In step 2.III, a preliminary measurement value m, for example the MPTA value m is calculated based on the 2D positions a of the landmarks LM. As above-mentioned, due to a possible deviation of the lower limb rotation in the 2D image data compared to a reference rotation, the measurement value m may deviate from a corrected value m\hat{ }.

In step 2.IV, a probability density function o\hat{ }_pdf of the 3D orientation parameters, i.e. the lower limb rotation, is determined based on the image data I of the lower extremity. Details of the determination of the function o\hat{ }_pdf are discussed in context with FIG. 3.

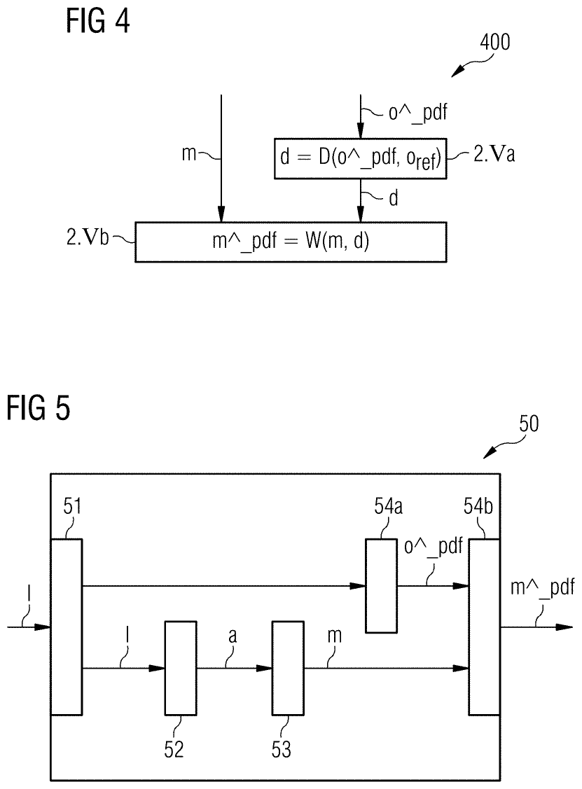

In step 2.V, a probability density function m\hat{ }_pdf of a corrected measurement value m\hat{ } is determined based on the preliminary measurement value m, the probability density function o\hat{ }_pdf of the 3D orientation parameters o and the reference orientation oref. Details of the calculation of the probability density function m\hat{ }_pdf of a corrected measurement value m\hat{ } are discussed in context with FIG. 4.

In FIG. 3, a flow chart diagram 300 is shown, which illustrates details of the determination of the function o\hat{ }_pdf in step 2.IV.

In step 2.IVa, a segmentation of the image data I is carried out. For that purpose a trained model is used to predict a label mask with pixel-level segmentations LMSK.

Then in step 2.IVb, from the label mask LMSK, measurement values my are determined for later predicting the probability density function o\hat{ }_pdf of the orientation of the examined object.

For example, the examined object is the lower limb and the orientation o\hat{ } of the lower limb, also named as rotation of the knee, can be calculated based on formula (8). The measurement values my comprise a first measurement value mv1, a second measurement value mv2 and a third measurement value mv3, wherein mv1=the visible part of the fibula (%), mv2=the overlapped part of the fibular tip (%), mv3=distance between the fibular tip and the lateral fibular cortex(%).

To train the model of step 2.IVa, for example a Deep Learning model, the concept of cross-modality training data generation can be employed as described above. Segmentation of anatomical structures can be carried out in the domain of CT images and segmentations can then be forward projected onto 2D image data.

In step 2.IVc the probability density function o\hat{ }_pdf of an orientation of the knee is determined based on formula (8).

In FIG. 4, a flow chart diagram 400 is shown, which illustrates details of the determination of the probability density function m \hat{ }_pdf of the corrected measurement value, in the specific embodiment, the MPTA value of the lower limb in step 2.V.

In step 2.Va, based on the probability density function o\hat{ }_pdf of an orientation of the knee and a reference orientation value oref, a difference d is determined. In the simplest case the difference value d is a difference between two scalar values, for example the measured and the reference rotation value of the knee.

In step 2.Vb, the probability density function m \hat{ }_pdf of a corrected measurement value m\hat{ } is calculated based on the determined difference value d and the preliminary measurement value m, using a trained model W.

To implement the model W, again the concept of cross-modality training data generation can be employed. By creation of synthetic X-ray images from the same CT volume with different 3D orientations one can determine once, the 2D measurement value m \hat{ }_pdf for the reference 3D orientation oref and N times, the 2D measurement value m for a 3D non-reference orientation o\hat{ }_pdf, to train the model W.

In FIG. 5, a schematic view on a correction device 50 is illustrated. The correction device 50 comprises an input interface unit 51 for receiving 2D image data I of an examination object, for example the 2D image data of a lower limb. The correction device 50 also comprises a landmark detection unit 52 for detecting landmarks LM in the 2D image data I and for estimating the 2D positions a of the landmarks LM. The correction device 50 also encompasses a preliminary measurement value determination unit 53 for determining a preliminary measurement value m based on the estimation of the 2D positions a of the landmarks LM. The correction device 50 further comprises an orientation prediction unit 54a for determining a probability density function o\hat{ }_pdf of an orientation of the examined object. The probability density function o\hat{ }_pdf is determined based on a trained model, for example a Deep Learning model.

The correction device 50 further includes a measurement value prediction unit 54b for predicting a corrected measurement value m \hat{ }_pdf of the examination object based on the probability density function o\hat{ }_pdf of an orientation of the examined object and the preliminary measurement value m using a trained model.

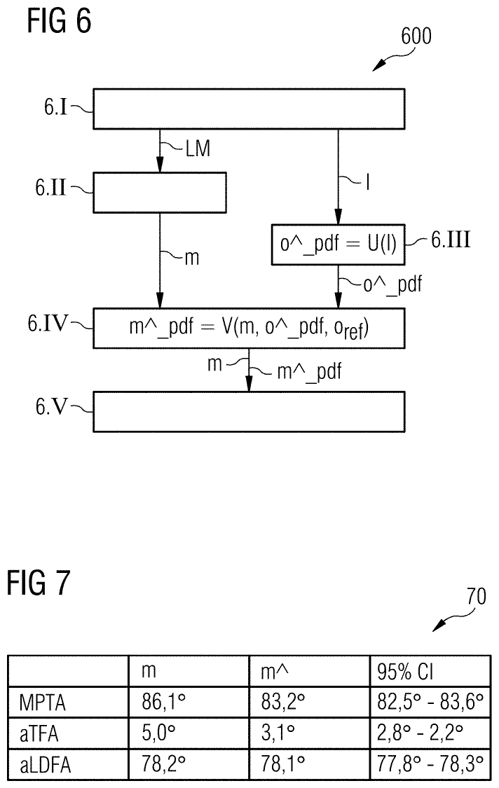

In FIG. 6, a flow chart 600 is illustrated, which is related to the method according to a second embodiment of the present invention, wherein a lower limb X-ray exam is carried out.

In a lower limb X-ray exam, many different parameters can be measured, which depend on the limb rotation to a different extend, as illustrated in FIG. 1. Often, several exams are acquired of the same patient at different time points and the measurement values should be compared. Today, doctors make these measurements unassisted and may take limb rotation subjectively into account. To aid doctors and to make the measurements more objective, the following sequence of steps is proposed.

In step 6.I, each X-ray image of a patient is measured conventionally based on the landmarks in the 2D image. A doctor sets the landmarks LM or, in a preferred scenario, an algorithm finds the landmarks.

In step 6.II, the preliminary measurement values m are calculated based on these 2D landmarks LM in the traditional way.

In step 6.III, in addition, based on the method according to the present invention, the probability density function o\hat{ }_pdf of the limb rotation is estimated taking into account X-ray image data I and in step 6.IV, the measurement values m \hat{ }_pdf concerning to the lower limb, for example the MPTA, aTFA, aLDFA values are predicted as if there was no limb rotation.

Then in step 6.V, for transparency, the doctor analyses both results. The uncorrected original measurement values m and the corrected results m \hat{ }_pdf with 95% confidence interval.

The doctor can then interpret the uncorrected or corrected values or an algorithm can support with the interpretation of the values.

In FIG. 7, a table is shown, which compares original values, i.e. preliminary measurement values m with corrected measurement values m \hat{ }_pdf for lower limb image data and a confidence interval CI. The estimated limb rotation of the image data is +10°. The measurement values m, m\hat{ } relate to MPTA, aTFA and aLDFA measurement values. As can be taken from the table in FIG. 7, the corrected MPTA value and the corrected aTFA value significantly differ from the corresponding measured value.

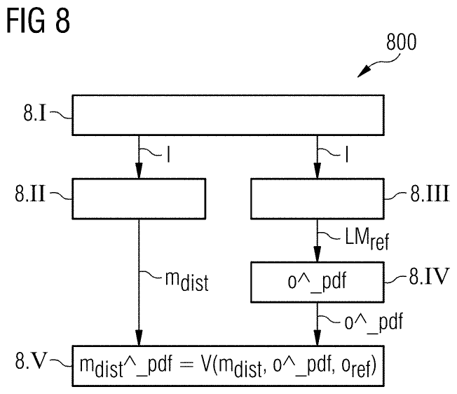

In FIG. 8, a flow chart 800 is illustrated, which is related to the method according to a third embodiment of the present invention, wherein a chest X-ray exam is carried out.

In the third embodiment, in step 8.I chest X-ray images I are acquired from a patient. In step 8.II the positioning of an external device (e.g. line) in the chest X-ray images I is checked. Here, the measurement value mdist relates to the distance between the line's tips and anatomical structures, for example the carina, to, for example, compare device locations in sequential examinations. Such an examination is highly relevant in practice.

In step 8.III, reference landmarks LMref are obtained from the chest X-ray images I.

In step 8.IV, the rotation and tilting information o\hat{ }_pdf is determined based on the reference landmarks LMref of the current 2D image I as it is done in clinical routine. For instance, distances between sternoclavicular joints and spine in chest X-ray images are used to estimate patient rotation o\hat{ }_pdf.

Having landmarks LMref segmented as heatmaps, it is straightforward to derive a probability o\hat{ }_pdf distribution using this approach. In that context, a linear transformation of normally distributed variables is used, which relates to a Gaussian probability density function o\hat{ }_pdf.

In step 8.V, the distance mdist\hat{ }_pdf as if there would be no rotation is determined by transforming one pdf, which is related to the measured distances mdist in actual X-ray image to another pdf, which is related to the measured distances mdist\hat{ }_pdf as if there would be no rotation.

FIG. 9 shows an X-ray imaging system 1, which comprises the correction device 50 shown in FIG. 5 in detail. The X-ray imaging system 1 essentially consists of a conventional acquisition unit 2 comprising an X-ray detector 2a and an X-ray source 2b opposite the X-ray detector 2a. Further, there is a patient table 3, the upper part of which with a patient P on it can be moved to the acquisition unit 2 in order to position the patient P under the X-ray detector 2a. The acquisition unit 2 and the patient table 3 are controlled by a control device 4, from which acquisition control signals (not shown in FIG. 9) come for controlling the imaging process and which receives measuring data MD from the X-ray detector 2a. The control unit 4 also comprises a post-processing unit 4a for generating post-processed 2D medical image data I based on the received measuring data MD.

The control unit 4 also includes the above-mentioned correction device 50 according to an example embodiment of the present invention. The medical image data I are analyzed by the correction device 50 and results o\hat{ }_pdf are stored in a data storage unit (not shown in FIG. 9).

The components of the correction device 50 can be implemented predominantly or completely in the form of software elements on a suitable processor. In particular, the interfaces between these components can also be designed purely in terms of software. All that is required is that there are access options to suitable storage areas in which the data can be stored temporarily and called up and updated at any time.

Further, the use of the undefined article “a” or “one” does not exclude that the referred features can also be present several times. Likewise, the term “unit” or “device” does not exclude that it consists of several components, which may also be spatially distributed.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

What is claimed is:

1. A method for correcting a 2D measurement value, the method comprising:
receiving 2D image data of an examination object;
detecting landmarks in the 2D image data;
estimating 2D positions of the landmarks; and
predicting a corrected measurement value of the examination object using a trained model, the trained model based on the 2D image data, the 2D positions of the landmarks and a reference parameter of a reference 3D orientation of the examination object.

2. The method according to claim 1, wherein the examination object comprises at least one of
an organ of a patient,
a part of a body of the patient,
a limb of the patient, or
a chest of the patient.

3. The method according to claim 1, wherein the trained model comprises a first trained model and a second trained model to be carried out one after another.

4. The method according to claim 3, wherein
an input of the first trained model includes the 2D image data, and
an output of the first trained model includes estimated 3D orientation parameters.

5. The method according to claim 4, wherein
an input for the second trained model includes
the estimated 3D orientation parameters,
the reference parameter of the reference 3D orientation of the examination object, and
a 2D measurement value to be corrected, the 2D measurement value depending on the 2D positions of the landmarks, and
an output of the second trained model includes the corrected 2D measurement value.

6. The method according to claim 3, wherein an input of the second trained model includes a difference between an estimated 3D orientation and the reference 3D orientation.

7. The method according to claim 3, wherein the first trained model is trained based on a multitude of synthetic 2D images of the examination object corresponding to different 3D orientation parameters.

8. The method according to claim 4, further comprising:
estimating the estimated 3D orientation parameters, the estimating including
segmenting anatomical structures of the 2D image data,
localizing the segmented anatomical structures, and
predicting 3D orientation parameters based on positions of the localized segmented anatomical structures.

9. The method according to claim 8, wherein the first trained model is configured to carry out the segmenting, which is trained by a multitude of synthetic 2D images, and wherein the output of the first trained model includes a label mask with segmentations.

10. The method according to claim 9, wherein
measurement values concerning the positions of the localized segmented anatomical structures are taken from the label mask, and
the 3D orientation parameters are predicted based on the measurement values.

11. The method according to claim 4, wherein at least one of
estimating of the estimated 3D orientation parameters in the 2D image data includes estimating a probability density function of the estimated 3D orientation parameters in the 2D image data, or
the predicting of the corrected measurement value of the examination object includes determining a probability density function of the corrected measurement value.

12. A correction device, comprising:
an input interface to receive 2D image data of an examination object;
a landmark detection unit to detect landmarks in the 2D image data, and to estimate 2D positions of the landmarks; and
a prediction unit to predict a corrected measurement value of the examination object using a trained model, the trained model based on the 2D image data, the 2D positions of the landmarks and a reference parameter of a reference 3D orientation of the examination object.

13. A medical imaging system, comprising:
an acquisition unit to acquire measuring data from an examination object;
a post-processor to generate post-processed 2D image data based on the measuring data; and
the correction device according to claim 12.

14. A non-transitory computer program product with a computer program, which is loadable into a memory device of a medical imaging system, the computer program including program sections that, when executed by the medical imaging system, cause the medical imaging system to perform the method according to claim 1.

15. A non-transitory computer readable medium storing program sections that, when executed by at least one processor of a medical imaging system, cause the medical imaging system to perform the method according to claim 1.

16. A correction device, comprising:
a memory storing computer-executable instructions; and
at least one processor configured to execute the computer-executable instructions to cause the correction device to
detect landmarks in 2D image data of an examination object,
estimate 2D positions of the landmarks, and
predict a corrected measurement value of the examination object using a trained model, the trained model based on the 2D image data, the 2D positions of the landmarks and a reference parameter of a reference 3D orientation of the examination object.

17. The method according to claim 4, wherein an input of the second trained model includes a difference between an estimated 3D orientation and the reference 3D orientation.

18. The method according to claim 5, wherein an input of the second trained model includes a difference between an estimated 3D orientation and the reference 3D orientation.

19. The method according to claim 5, wherein at least one of
estimating of the estimated 3D orientation parameters in the 2D image data includes estimating a probability density function of the estimated 3D orientation parameters in the 2D image data, or
the predicting of the corrected measurement value of the examination object includes determining a probability density function of the corrected measurement value.

20. The method according to claim 8, wherein at least one of
estimating of the estimated 3D orientation parameters in the 2D image data includes estimating a probability density function of the estimated 3D orientation parameters in the 2D image data, or
the predicting of the corrected measurement value of the examination object includes determining a probability density function of the corrected measurement value.
